(19) United States
(12) Patent Application Publication
(10) Pub. No.: US 2018/0365254 A1
(43) Pub. Date: Dec. 20, 2018

(54) METHOD AND APPARATUS FOR PROCESSING INFORMATION FLOW DATA

(71) Applicant: BEIJING QIHOO TECHNOLOGY COMPANY LIMITED, Beijing (CN)

(72) Inventor: Zhao HUANG, Beijing (CN)

(21) Appl. No.: 15/739,881

(22) PCT Filed: Jun. 23, 2016
(86) PCT No.: PCT/CN2016/086876

§ 371 Date: Dec. 26, 2017

(30) Foreign Application Priority Data
Jun. 26, 2015 (CN) 201510364378.4

(51) Int. Cl. G06F 17/30; G06F 9/48; H04L 29/08; G06F 9/54

(52) U.S. Cl. CPC G06F 17/3089; G06F 9/4843; G06F 9/542; H04L 67/02; H04L 67/26

(57) ABSTRACT

Embodiments of the present invention provide a method and an apparatus for processing information flow data. The method comprises: when a processing request based on an event initiated by a first user identity is received, processing the event according to the processing request, the event having an event identifier; searching for a second user identity subscribing to information of the first user identity; the second user identity having an associated information flow list; writing the event identifier into the information flow list; and sending, to a client corresponding to the second user identity, event information corresponding to the event identifier in the information flow list.

### CROSS-REFERENCE TO RELATED APPLICATIONS

This application is the national stage of International Application No. PCT/CN2016/086876 filed Jun. 23, 2016, which claims the benefit of Chinese Patent Application No. CN201510364378.4, filed Jun. 26, 2015, the entirety of which are incorporated herein by reference.

### FIELD OF TECHNOLOGY

The present invention relates to the field of computer processing technologies, and in particular, to a method for processing information flow data and an apparatus for processing information flow data.

### BACKGROUND

With the development of network science technology, many products such as Blog, SNS (Socnal Network Site), RSS (Really Simple Syndication) et, al are introduced with user follow function. The users may see history behavior of the person he or she follows in the applications.

In these products, a Feed (information flow) system is widely used in a majority of applications, and generally Feed (information flow) data need to be published via a push mode or pull mode.

In the push mode, a Feed (information flow) list needs to be maintained for each user. When a user performs a particular behavior (for example, publishing a short message), a system may push data to the Feed (information flow) list of users (commonly known as “fans”) following the user.

The push mode may allow the user to quickly and conveniently acquire the Feed (information flow) data. However, when the user has a lot of fans, each particular behavior of the user may cause mass push requests, which may greatly increase the load of a server. During a peak period of pushing requests, mass push requests may scramble for public resources with other businesses or services (i.e., “Herd Effect”), which may cause occurrence of an unpredictable case.

In the pull mode, when a user performs a particular behavior (for example, publishing a short message), the short message may be stored in a temporary Feed (information flow) list (which merely saves data of an acceptable range in recent time), and the user pulls Feed (information flow) data from the Feed (information flow) list as needed.

The pull mode is simple in design and saves storage space. However, generally the Feed (information flow) list needs to save the Feed (information flow) data within the recent ten or fifteen days, which may generate a great deal of stress. When the user follows a lot of objects, the stress to a database may be large, which may have a negative effect on the efficiency of pulling data. Furthermore, clients may be periodically scanned for general on-line users, which may further increase a great deal of stress, and thus may likely cause request latency or even failure.

### SUMMARY

In view of the above problems, the present invention is proposed to provide a method for processing information flow data and a corresponding apparatus for processing information flow data to overcome or at least partially solve the above problems.

According to an aspect of the present invention, there is provided a method for processing information flow data, comprising:

processing, when a processing request based on an event initiated by a first user identity is received, the event according to the processing request, the event having an event identifier;

searching for a second user identity subscribing to information of the first user identity, the second user identity having an associated information flow list;

writing the event identifier into the information flow list; and

sending, to a client corresponding to the second user identity, event information corresponding to the event identifier in the information flow list.

According to another aspect of the present invention, there is provided an apparatus for processing information flow data, comprising:

an event processing module, configured to process, when a processing request based on an event initiated by a first user identity is received, the event according to the processing request, the event having an event identifier;

a user identity searching module, configured to search for a second user identity subscribing to information of the first user identity, the second user identity having an information flow list;

an information flow list writing module, configured to write the event identifier into the information flow list; and

an event information sending module, configured to send, to a client corresponding to the second user identity, event information corresponding to the event identifier in the information flow list.

According to the embodiments of the present invention, the event identifier of the event triggered based on the first user identity is written into the information flow list associated with the second user identity subscribing to the information of the first user identity, corresponding event information is sent when the second user identity is associated with an online status, and the event is integrated and uniformly processed within an allowable time delay range by means of asynchronous push, so that the number of concurrent executions of data is reduced, and the load on a server is greatly decreased.

According to the embodiments of the present invention, event tasks are executed in order via a task queue. On one hand, data recovery means in the event of a disaster are increased, and on the other hand, it is guaranteed task priority differentiation according to a time dimension.

A Redis database in the embodiments of the present invention supports highly concurrent read-write operations, guarantees timeliness in read-write updating user information, and guarantees the user experience.

Described above is merely an overview of the technical solution of the present invention. In order to more apparently understand the technical means of the present invention to implement in accordance with the contents of specification, and to more readily understand above and other objectives, features and advantages of the present invention, specific embodiments of the present invention are provided hereinafter.

### BRIEF DESCRIPTION OF THE DRAWINGS

Various other advantages and benefits will become apparent to those of ordinary skill in the art by reading the detailed description of the following preferred embodiments. The accompanying drawings are merely intended for showing preferred embodiments, but are not deemed to limit the present invention. Further, throughout the drawings, same elements are indicated by same reference numbers. In the drawings:

FIG. 1 illustrates a step flowchart of an embodiment of a method for processing information flow data according to an embodiment of the present invention;

FIG. 2 illustrates an architecture diagram of a Feed system according to an embodiment of the present invention;

FIG. 3 illustrates an example diagram of a processing procedure of a daemon according to an embodiment of the present invention; FIG. 4 illustrates a schematic structural diagram of an embodiment of an apparatus for processing information flow data according to an embodiment of the present invention;

FIG. 5 is a block diagram of a computing device for executing the method for processing information flow data according to the present invention; and

FIG. 6 is a memory cell for maintaining or carrying a program code for implementing the method for processing information flow data according to the present invention.

### DESCRIPTION OF THE EMBODIMENTS

The following will describe in more detail the exemplary embodiments of the disclosure with reference to the accompanying drawings. Although the accompanying drawings display the exemplary embodiments of the disclosure, it should be understood that the disclosure may be implemented in various forms but not limited by the embodiments set forth herein. Instead, these embodiments are provided to more thoroughly understand the disclosure, and completely convey the scope of the disclosure to those skilled in the art.

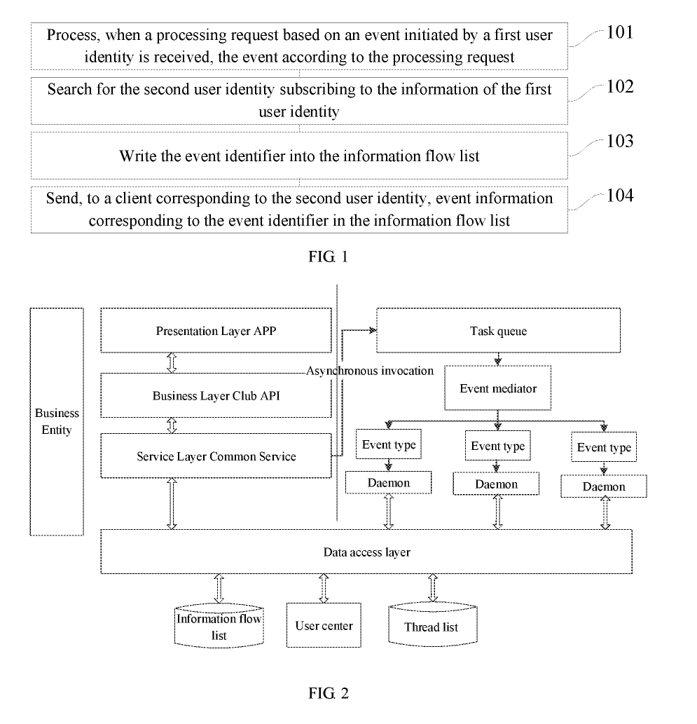

Referring to FIG. 1, a step flowchart of an embodiment of a method for processing information flow data according to an embodiment of the present invention is illustrated, the method specifically may comprise following steps.

Step 101: processing, when a processing request based on an event initiated by a first user identity is received, the event according to the processing request.

Feed (information flow) refers to a list of the latest content published on a website, and a user may receive the latest content published after subscribing to the Feed (information flow) on the website.

Referring to FIG. 2, an architecture diagram of a Feed system according to an embodiment of the present invention is illustrated. As shown in FIG. 2, the Feed system is an independent background asynchronous system that provides a business entity outward, for example, Post Bar (a topic exchange community based on a keyword), Blog, Microblog and so on.

A presentation layer in the Feed system faces the user and is characterized as an application (APP) such as a browser, an instant messenger, an independent client, and the like.

A business layer in the Feed system provides a Club API (a common interface). The user can log into the APP, invoke the Club API of the Feed system through an operation of the APP, send a processing request of a certain event, request the Feed system to process the event to apply these entity businesses, for example, publishing posts in Post Bar, blogging on blogs, publishing messages on Microblog, etc.

A service layer in the Feed system provides a common service. Corresponding processes may be carried out when a processing request from the Club API is received.

In specific implementation, the event may be publishing information, following an object and some individual behaviors, etc.

For publishing information, the Feed system may store event information (for example, posts published at Post Bar, blogs published on Blog, and messages published on Microblog) of the event in a database (such as a relational database MySQL).

To recognize the event, the Feed system may configure an event identifier (Tid) for the event, for example, the ID of the published post, and the ID of the followed object, etc.

Step 102: searching for the second user identity subscribing to the information of the first user identity.

By using the embodiments of the present invention, a user (characterization of the second user identity, such as a user account, and a user ID or the like) may subscribe to information of another user (characterization of the first user identity, such as a user account, and a user ID or the like) in advance by operation of following or establishing a friend relationship, such as posts published at Post Bar, blogs published on Blog, and messages published on Microblog, etc.

In specific implementation, as shown in FIG. 2, a user center (User Center SDK) may be accessed through a data access layer (Database Layer) in the Feed system. User-related information is stored in the user center, comprising a subscription relationship. The second user identity subscribing to information of the first user identity is determined according to the subscription relationship.

The second user identity has an information flow list (Feed List), in which the information to which the second user identity subscribes may be stored.

In a preferred embodiment of the present invention, Step 102 may comprise the following substeps:

Substep S11: generating an event task;

wherein the event task may comprise the first user identity, the event identifier, and an event type;

Substep S12: writing the event task into a preset task queue;

Substep S13: reading the event task by a preset daemon from the task queue; and

Substep S14: searching, by the preset daemon, for the second user identity subscribing to the information of the first user identity.

As shown in FIG. 2, in the Feed system, a task queue (Event Queue) may be asynchronously invoked, and an event task may be pushed to the task queue.

Taking a Kafka system as an example, the Kafka system generally comprises a plurality of producers (such as the service layer in the Feed system), a plurality of brokers, a plurality of consumers (such as the daemon in the Feed system), and a Zookeeper management cluster.

The Kafka system is configured via the Zookeeper management cluster to select a leader and rebalance when a change takes place in the consumer.

The producer produces a message (an event task) and uses a push mode to publish the message to the broker.

Each type of message (event task) is defined as a topic, and messages within the same topic are partitioned and stored on different brokers according to a certain key and algorithm.

The consumer uses a pull mode to subscribe and consume messages from the corresponding topic in the broker.

In practical application, in the broker, the message queue is stored in the form of a log file. The producer adds the message (event task) to the tail of the existing log file. There is no ID information for positioning the message, just depending on the displacement in the file. Therefore, the consumer relies on a file displacement sequence to read messages. As a result, it is unnecessary to maintain a complex index structure (namely FIFO, First In First Out) supporting random access.

In the embodiments of the present invention, a plurality of task queues may be preset, and a task event of each task queue has the same event type. When the event task is pushed, the event task may be written into a preset task queue that matches the event type. Using the embodiments of the present invention, the daemon may be deployed in advance.

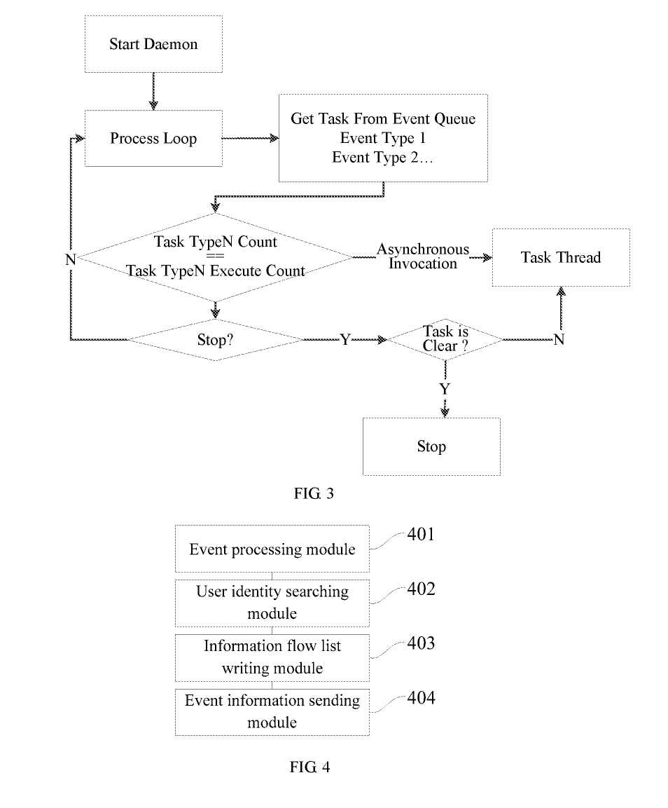

As shown in FIG. 3, in the Feed system, first, the daemon is started to enter the task process loop, a task thread is periodically created according to a configuration parameter, a task event is acquired from the task queue (Get Task From Event Queue), the event type (Task Type 1, Task Type 2 . . . ) of the task event is resolved, and a task thread is asynchronously invoked to execute the event task (Task TypeN Count==Task TypeN Execute Count).

The daemon decides whether an externally transferred stop signal is received (Stop?). The task process loop is continued when the decision result is N; otherwise creating the task thread is stopped when the decision result is Y. It is decided whether the task of the current task thread is completed (Task is Clear?). It is waited until the task of the current task thread is completed when the decision result is N; otherwise the daemon is stopped when the decision result is Y.

It is to be noted that the daemon takes a task out from the task queue, the task may be marked as removed out of the queue, what is gained is null data when the queue is empty, and the daemon may enter into a short dormancy. In the embodiments of the present invention, as shown in FIG. 2, daemons of different servers may be deployed so that event tasks may be periodically acquired from a task queue. An event mediator invokes a sub-thread of a daemon (event process) according to the event type to execute different operations, and different strategies are executed for different event types, so that the priority levels of the event tasks are controlled.

Information of the sub-thread of the daemon (event process) is maintained in a thread list.

A read frequency may be preset for each event type, and the event task may be read by the preset daemon from the task queue by way of FIFO according to the read frequency set for the event type.

Further, the event type has a priority, and the read frequency of a first event type is higher than that of a second event type.

The first event type is an event type whose priority is higher than that of the second event type.

The second event type is an event type whose priority is lower than that of the first event type.

That is, the read frequency of an event type having a higher priority is higher than that of an event type having a lower priority. The daemon searches for the second user identity subscribing to the information of the first user identity when the event type is a publish type.

For the user's behaviors of publishing posts, blogging, publishing messages on Microblog and so on, when the user has published a message, the message may be pushed to the user's fans' FeedList, which does not require a high real-time performance, and the number of the fans is uncontrollable, so that the read frequency is lower to ensure the processing stability.

The daemon searches for a subscribed third user identity when the event type is a subscription type.

For the user's following behavior, when the user has followed an object, the user may see historical information behaviors of the object in the FeedList. Therefore, higher real-time performance is required to process this task, and the read frequency is higher.

Based on the above different business scenarios, parameters such as dormancy time spent by the daemon in consuming different task events and the number of the task events acquired from the queue depends on dimensions such as real-time performance and stability respectively.

In the embodiments of the present invention, the event tasks are performed in order according to the task queue. On one hand, the event tasks are consumed according to FIFO of time dimensions, according to data backup mechanisms of task queues based on, for example, the Kafka system, in case of a program exception, a part of the acquired data are not resolved, so that the corresponding tasks may be taken out from the backup of the queue according to the time period of the exception to resolve, thereby increasing data recovery means in the event of a disaster. On the other hand, the event tasks are consumed according to FIFO of time dimensions, so that it is ensured that the event tasks are performed in order and it is guaranteed task priority differentiation according to a time dimension.

Step 103: writing the event identifier into the information flow list.

In specific implementation, the preset daemon writes the event identifier into the information flow list stored in a Redis database.

The daemons are respectively deployed in a plurality of online servers, the daemons generally are independent and non-coupled, and meanwhile the event tasks are acquired from a task queue. It may be ensured that the event tasks can be moved out in order based on a synchronous serial mode of moving the tasks out from the task queue.

In the embodiments of the present invention, to ensure the timeliness of data processing, a Redis supporting highly concurrent application scenarios is used as a storage medium, and data are continuously fed into the FeedList of the user.

As a non-relational database supporting high concurrency, the Redis is characterized by fast data read-write speed compared with a traditional relational database, available for reaching above 50,000 concurrencies per second, and suitable for application in highly concurrent business scenarios. The Redis can reduce performance bottleneck caused by data storage in case of high concurrency and support asynchronous persistence functions, and thus is more reliable than MemCache (a distributed cache system) in disaster recovery and storage security.

The Redis database in the embodiments of the present invention supports highly concurrent read-write operations, guarantees timeliness in read-write updating user information, and guarantees the user experience.

Step 104: sending, to a client corresponding to the second user identity, event information corresponding to the event identifier in the information flow list.

In specific implementation, when the second user identity is associated with an online status, the event information corresponding to the event identifier is sent to the client corresponding to the second user identity according to a time sequence of the event identifier in the information flow list.

That is, after logging onto an APP, the user acquires Feed information from the FeedList according to time sequence.

Further, in the Feed system, event information corresponding to an event identifier may be extracted from a database (such as a relational database MySQL) and sent to the client.

The Feed information is machine-readable, so that information may be transferred between computers without manual intervention. Source codes may be converted by a browser plug-in, a client application referred to as “reader” or an API into human-readable texts and displayed to the user.

According to the embodiments of the present invention, the event identifier of the event triggered based on the first user identity is written into the information flow list associated with the second user identity subscribing to the information of the first user identity, corresponding event information is sent when the second user identity is associated with an online status, and the event is integrated and uniformly processed within an allowable time delay range by means of asynchronous push, so that the number of concurrent executions of data is reduced, and the load on a server is greatly decreased.

It should be explained that, for a brief description, method embodiments are describe as a combination of a series of motions. However, those skilled in the art should know that the embodiments of the present invention are not limited by sequences of the motions described. This is because some steps may be performed by using other sequences or be performed simultaneously in accordance with the embodiments of the present invention. In addition, those skilled in the art should also learn that the embodiments described in the specification are preferred embodiments, and involved motions are not necessary for the embodiments of the present invention.

Referring to FIG. 4, which illustrates a schematic structural diagram of an embodiment of an apparatus for processing information flow data according to an embodiment of the present invention, the apparatus specifically may comprise following modules:

an event processing module 401, configured to process, when a processing request based on an event initiated by a first user identity is received, the event according to the processing request, the event having an event identifier;

a user identity searching module 402, configured to search for a second user identity subscribing to information of the first user identity, the second user identity having an information flow list;

an information flow list writing module 403, configured to write the event identifier into the information flow list; and

an event information sending module 404, configured to send, to a client corresponding to the second user identity, event information corresponding to the event identifier in the information flow list.

In an alternative example of this embodiment of the present invention, the event processing module 401 also may be configured to:

store the event information of the event in a database.

In an alternative embodiment of the present invention, the user identity searching module 402 may be further configured to:

generate an event task, the event task comprising the first user identity and the event identifier;

write the event task into a preset task queue;

read the event task by a preset daemon from the task queue; and

search, by the preset daemon, for the second user identity subscribing to the information of the first user identity.

In an alternative embodiment of the present invention, the event task may further comprise an event type; and the user identity searching module 402 may be further configured to:

write the event task into the preset task queue matching the event type.

In an alternative embodiment of the present invention, the user identity searching module 402 may be further configured to:

read the event task by the preset daemon from the task queue by way of FIFO according to a read frequency set for the event type.

In specific implementation, the event type may have a priority, and the read frequency of a first event type is higher than that of a second event type.

The first event type is an event type whose priority is higher than that of the second event type.

The second event type is an event type whose priority is lower than that of the first event type.

In an alternative embodiment of the present invention, the event task may further comprise an event type; and the user identity searching module 402 may be further configured to:

search, by the daemon, for the second user identity subscribing to the information of the first user identity when the event type is a publish type.

In an alternative example of this embodiment of the present invention, the information flow list writing module 403 may be further configured to:

write, by the preset daemon, the event identifier into the information flow list stored in a Redis database.

In an alternative embodiment of the present invention, the event information sending module 404 may be further configured to:

send, to the client corresponding to the second user identity, the event information corresponding to the event identifier according to a time sequence of the event identifier in the information flow list when the second user identity is associated with an online status.

Device embodiments are basically similar to method embodiments, so description of device embodiments is relatively simple. Please see method embodiments which may serve as reference.

Algorithm and display provided herein are not inherently related to a particular computer, virtual system or other equipment. Various general systems may also be used with the teaching based on the disclosure. According to the above description, the required structure for constructing such a system is obvious. In addition, the present invention is not directed to any particular programming language. It should be understood that a variety of programming languages can be used to implement the disclosed contents as described herein and above description to the particular programming language is to disclose the best inventive implementation mode.

Many details are discussed in the specification provided herein. However, it should be understood that the embodiments of the present invention can be implemented without these specific details. In some examples, the well-known methods, structures and technologies are not shown in detail so as to avoid an unclear understanding of the description.

Similarly, it should be understood that, in order to simplify the disclosure and to facilitate the understanding of one or more of various aspects thereof, in the above description of the exemplary embodiments of the present invention, various features of the present invention may sometimes be grouped together into a single embodiment, accompanying figure or description thereof. However, the method of this disclosure should not be constructed as follows: the present invention for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the present invention.

It should be understood by those skilled in the art that modules of the device in the embodiments can be adaptively modified and arranged in one or more devices different from the embodiment. Modules, units or components in the embodiment can be combined into one module, unit or component, and also can be divided into more sub-modules, sub-units or sub-components. Except that at least some of features and/or processes or units are mutually exclusive, various combinations can be used to combine all the features disclosed in specification (comprising claims, abstract and accompanying figures) and all the processes or units of any methods or devices as disclosed herein. Unless otherwise definitely stated, each of features disclosed in specification (comprising claims, abstract and accompanying figures) may be taken place with an alternative feature having same, equivalent or similar purpose.

In addition, it should be understood by those skilled in the art, although some embodiments as discussed herein comprise some features comprised in other embodiment rather than other feature, combination of features in different embodiment means that the combination is within a scope of the present invention and forms the different embodiment. For example, in the claims, any one of the embodiments for which the protection is sought can be used in any combination manner.

Each of devices according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the parts in the apparatus for processing information flow data according to the embodiments of the present invention. The present invention may further be implemented as equipment or device program (for example, computer program and computer program product) for executing some or all of the methods as described herein. Such program for implementing the present invention may be stored in the computer readable medium, or have a form of one or more signals. Such a signal may be downloaded from the Internet websites, or be provided on a carrier signal, or provided in any other form.

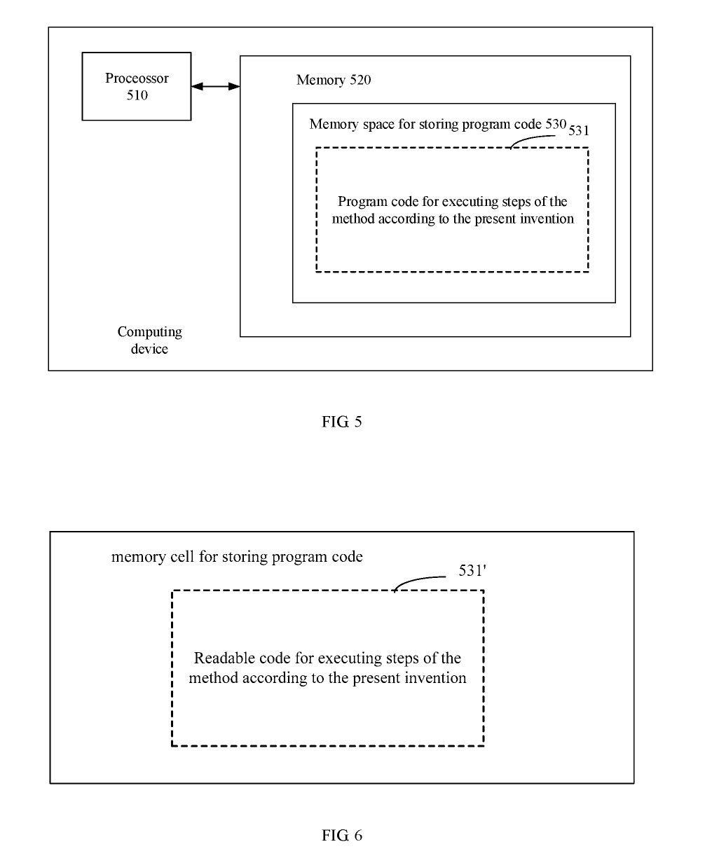

For example, FIG. 5 illustrates a computing device for executing the method for processing information flow data according to the present invention. Traditionally, the computing device includes a processor 510 and a program product or a readable medium in form of a memory 520. The memory 520 could be electronic memories such as flash memory, EEPROM (Electrically Erasable Programmable Read-Only Memory), EPROM or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more program products. These program products include program code carriers such as memory card. These program products are usually the portable or stable memory cells as shown in reference FIG. 6. The memory cells may be provided with memory sections, memory spaces, etc., similar to the memory 520 of the computer device as shown in FIG. 5. The program codes may be compressed for example in an appropriate form. Usually, the memory cell includes readable codes 531′ which can be read for example by processors 510. When these codes are operated on the computing device, the computing device may execute respective steps in the method as described above.

It should be noted that the above-described embodiments are intended to illustrate but not to limit the present invention, and alternative embodiments can be devised by a person skilled in the art without departing from the scope of claims as appended. In the claims, no reference mark between round brackets shall impose restriction on the claims. The word “comprise” does not exclude a component or step not listed in the claims. The wording “a” or “an” in front of an element does not exclude the presence of a plurality of such elements. The present invention may be realized by way of hardware comprising a number of different components and by way of a suitably programmed computer. In the unit claim listing a plurality of devices, some of these devices may be embodied in the same hardware. The wordings “first”, “second”, and “third”, etc. do not denote any order. These wordings can be construed as naming.

1. A method for processing information flow data, comprising:
processing, when a processing request based on an event initiated by a first user identity is received, the event according to the processing request, the event having an event identifier;
searching for a second user identity subscribing to information of the first user identity, the second user identity having an associated information flow list;
writing the event identifier into the information flow list; and
sending, to a client corresponding to the second user identity, event information corresponding to the event identifier in the information flow list.

2. The method according to claim 1, wherein the step of processing the event according to the processing request comprises:
storing the event information of the event in a database.

3. The method according to claim 1, wherein the step of searching for a second user identity subscribing to information of the first user identity comprises:
generating an event task, the event task comprising the first user identity and the event identifier;
writing the event task into a preset task queue;
reading the event task by a preset daemon from the task queue; and
searching, by the preset daemon, for the second user identity subscribing to the information of the first user identity.

4. The method according to claim 3, wherein the event task further comprises an event type; and
wherein the step of writing the event task into a preset task queue comprises:
writing the event task into the preset task queue matching the event type.

5. The method according to claim 4, wherein the step of reading the event task by a preset daemon from the task queue comprises:
reading the event task by the preset daemon from the task queue by way of FIFO according to a read frequency set for the event type.

6. The method according to claim 5, wherein the event type has a priority, the read frequency of a first event type is higher than that of a second event type;
wherein the first event type is an event type whose priority is higher than that of the second event type; and
wherein the second event type is an event type whose priority is lower than that of the first event type.

7. The method according to claim 3, wherein the event task further comprises an event type; and
the step of searching, by the daemon, for the second user identity subscribing to the information of the first user identity comprises:
searching, by the daemon, for the second user identity subscribing to the information of the first user identity when the event type is a publish type.

8. The method according to claim 1, wherein the step of writing the event identifier into the information flow list comprises:
writing, by the preset daemon, the event identifier into the information flow list stored in a Redis database.

9. The method according to claim 1, wherein the step of sending, to a client corresponding to the second user identity, event information corresponding to the event identifier in the information flow list comprises:
sending, to the client corresponding to the second user identity, the event information corresponding to the event identifier according to a time sequence of the event identifier in the information flow list when the second user identity is associated with an online status.

10. A computing device, comprising:
a memory having instructions stored thereon;
a processor configured to execute the instructions to perform operations for processing information flow, the operations comprising:
processing, when a processing request based on an event initiated by a first user identity is received, the event according to the processing request, the event having an event identifier;
searching for a second user identity subscribing to information of the first user identity, the second user identity having an information flow list;
writing the event identifier into the information flow list; and
sending, to a client corresponding to the second user identity, event information corresponding to the event identifier in the information flow list.

11. The computing device according to claim 10, wherein the processing the event according to the processing request further comprises:
storing the event information of the event in a database.

12. The computing device according to claim 10, wherein the searching for a second user identity subscribing to information of the first user identity further comprises:
generating an event task, the event task comprising the first user identity and the event identifier;
writing the event task into a preset task queue;
reading the event task by a preset daemon from the task queue; and
searching, by the preset daemon, for the second user identity subscribing to the information of the first user identity.

13. The computing device according to claim 12, wherein the event task further comprises an event type; and the writing the event task into a preset task queue further comprises:
writing the event task into the preset task queue matching the event type.

14. The computing device according to claim 13, wherein the reading the event task by a preset daemon from the task queue further comprises:
reading the event task by the preset daemon from the task queue by way of FIFO according to a read frequency set for the event type.

15. The computing device according to claim 14, wherein the event type has a priority, the read frequency of a first event type is higher than that of a second event type;
wherein the first event type is an event type whose priority is higher than that of the second event type; and
wherein the second event type is an event type whose priority is lower than that of the first event type.

16. The computing device according to claim 12, wherein the event task further comprises an event type; and the searching, by the daemon, for the second user identity subscribing to the information of the first user identity comprises:
searching, by the daemon, for the second user identity subscribing to the information of the first user identity when the event type is a publish type.

17. The computing device according to claim 10, wherein the writing the event identifier into the information flow list further comprises:
writing, by the preset daemon, the event identifier into the information flow list stored in a Redis database.

18. The computing device according to claim 10, wherein the sending, to a client corresponding to the second user identity, event information corresponding to the event identifier in the information flow list further comprises:
sending, to the client corresponding to the second user identity, the event information corresponding to the event identifier according to a time sequence of the event identifier in the information flow list when the second user identity is associated with an online status.

19. (canceled)

20. A non-transitory-computer-readable medium having computer programs stored thereon that, when executed by one or more processors of a computing device, cause the computing device to perform operations for processing information flow, the operations comprising:
processing, when a processing request based on an event initiated by a first user identity is received, the event according to the processing request, the event having an event identifier;
searching for a second user identity subscribing to information of the first user identity, the second user identity having an associated information flow list;
writing the event identifier into the information flow list; and
sending, to a client corresponding to the second user identity, event information corresponding to the event identifier in the information flow list.

21. The non-transitory computer-readable medium according to claim 20, wherein the operation of processing the event according to the processing request comprises:
storing the event information of the event in a database.
